(19) United States
(12) Patent Application Publication
(10) Pub. No.: US 2025/0028145 A1
(43) Pub. Date: Jan. 23, 2025

(54) OPTICAL ELEMENT DRIVING MECHANISM

(71) Applicant: TDK TAIWAN CORP., Taoyuan City (TW)

(72) Inventors: Ying-Jen WANG, Taoyuan City (TW); Yi-Ho CHEN, Taoyuan City (TW); Ya-Hsiu WU, Taoyuan City (TW)

(21) Appl. No.: 18/777,880

(22) Filed: Jul. 19, 2024

Related U.S. Application Data
(60) Provisional application No. 63/514,958, filed on Jul. 21, 2023.

(51) Int. Cl. G02B 7/08; G02B 27/64

(52) U.S. Cl. CPC G02B 7/08; G02B 27/646

(57) ABSTRACT

An optical element driving mechanism is provided. The optical element driving mechanism includes a fixed portion, a movable portion and a first driving component. The movable portion is connected to an optical element having an optical axis. The movable portion is movable relative to the fixed portion. The first driving component is configured to drive the movable portion to move relative to the fixed portion.

### CROSS REFERENCE TO RELATED APPLICATIONS

This application claims the benefit of U.S. Provisional Application No. 63/514,958, filed Jul. 21, 2023, the entirety of which is incorporated by reference herein.

### BACKGROUND OF THE INVENTION

### Field of the Invention

The present invention relates to an optical element driving mechanism, and in particular it relates to an optical element driving mechanism with a driving component.

### Description of the Related Art

With the advancement of technology, many electronic devices today (such as smartphones) have photo-taking or video-recording capabilities. The use of these electronic devices is becoming increasingly widespread, and they are being developed to be more convenient and slimmer, to provide users with more options.

The aforementioned electronic devices with photo-taking or video-recording capabilities usually have an optical element driving mechanism, where light can pass through optical elements (such as shutter blades, filters, lenses, etc.) to form an image on the image sensor. The current trend in mobile devices is toward miniaturization and weight reduction, so how to effectively miniaturize and reduce the weight of an optical element driving mechanism has become an important issue.

### BRIEF SUMMARY OF THE INVENTION

The present disclosure provides an optical element driving mechanism. The optical element driving mechanism includes a fixed portion, a movable portion and a first driving component. The movable portion is connected to an optical element having an optical axis. The movable portion is movable relative to the fixed portion. The first driving component is configured to drive the movable portion to move relative to the fixed portion.

According to some embodiments of the present disclosure, the optical element driving mechanism further includes a guide element. The movable portion includes a first movable portion and a second movable portion. The second movable portion is movable relative to the first movable portion. The guide element guides the movement of the second movable portion relative to the first movable portion.

According to some embodiments of the present disclosure, the fixed portion includes a base. The base at least partially overlaps the guide element when viewed along the optical axis. During assembly of the optical element driving mechanism, the guide element is assembled to the first movable portion from a direction opposite the direction in which light enters the optical element driving mechanism.

According to some embodiments of the present disclosure, the first movable portion includes a first stopper, a second stopper, and a groove. When the second movable portion moves to the first limit position along the optical axis, the second movable portion contacts the first stopper. When the second movable portion moves to the second limit position along the optical axis, the second movable portion contacts the second stopper. The groove accommodates the guide element to secure the guide element on the first movable portion. The groove is located on the first stopper of the first movable portion.

According to some embodiments of the present disclosure, the optical element driving mechanism further includes a second driving component, a first circuit component and a second circuit component. The second driving component is configured to drive the second movable portion to move relative to the fixed portion and the first movable portion. The first driving component is electrically connected to the first circuit component. The first circuit component includes a first circuit element and a second circuit element. The first circuit element and the second circuit element are perpendicular to each other. The second driving component is electrically connected to an external circuit via the second circuit component. The first driving component includes a first magnetically permeable element, a second magnetically permeable element and a third magnetically permeable element. The second driving component includes two magnetically permeable elements. The first magnetically permeable element and the second magnetically permeable element are arranged on the first movable portion parallel to each other. The third magnetically permeable element is disposed on the first movable portion and is perpendicular to the first magnetically permeable element and the second magnetically permeable element. The magnetically permeable element is parallel to the third magnetically permeable element. One of the magnetically permeable elements is disposed on the first movable portion, and the other magnetically permeable element is disposed on the second movable portion.

According to some embodiments of the present disclosure, the second circuit component includes a circuit element, a connecting element, an elastic element, and a support element. The second driving component is electrically connected to the external circuit via the circuit element, the connecting element, the elastic element and the support element in sequence. The connecting element is embedded in the first movable portion. The support element supports the movement of the movable portion relative to the fixed portion. The support element is generally parallel to the optical axis, but the end of the support element closer to the elastic element is inclined toward the movable portion at an angle of less than 1 degree. The support element has a wire diameter of approximately 0.06 mm.

According to some embodiments of the present disclosure, during assembly of the optical element driving mechanism, the circuit element is soldered from the side facing away from the optical axis, so that the circuit element may be electrically connected to the connecting element.

According to some embodiments of the present disclosure, the elastic element includes a first connection point, a second connection point and a connection line. The first connection point and the second connection point are located at opposite ends of the connection line. The first connection point is provided on the second movable portion. The second connection point is provided on the first movable portion.

According to some embodiments of the present disclosure, an aperture mechanism is disposed on the second movable portion. The aperture mechanism is electrically connected to the elastic element via a first connection point of the elastic element. The circuit element is electrically connected to the second connection point of the elastic element via the connecting element. The first connection point is disposed on the side of the movable portion that is closer to the guide element. The second connection point is disposed on the side of the movable portion that is further away from the guide element.

According to some embodiments of the present disclosure, the optical element driving mechanism further includes two elastic elements and a plurality of suppression elements. The fixed portion includes a base. The base includes an opening. During assembly of the optical element driving mechanism, one of the suppressing elements may be applied from outside the base through the opening to the inside of the base. One of the suppression elements is provided between the elastic elements to prevent the elastic elements from colliding and causing damage.

### BRIEF DESCRIPTION OF THE DRAWINGS

Embodiments of the present disclosure will be described in detail below with reference to the accompanying drawings. It should be noted that, in accordance with standard industry practices, various features are not drawn to scale and are for illustrative purposes only. In fact, the dimensions of the elements may be arbitrarily enlarged or reduced in order to clearly illustrate the features of the present disclosure.

FIG. 1 is a perspective view of an optical element driving mechanism according to some embodiments of the present disclosure.

FIG. 2 is an exploded view of the optical element driving mechanism according to some embodiments of the present disclosure.

FIG. 3A shows a perspective view of a first driving component, a first circuit element, a second circuit element and a position sensing element that are disposed on a base.

FIG. 3B shows an exploded view of the first driving component, the first circuit element, the second circuit element and the position sensing element that are disposed on the base.

FIG. 4 shows a schematic side view of part of the first driving component.

FIG. 5A shows a perspective view of a first movable portion a second movable portion viewed from bottom to top.

FIG. 5B shows a bottom view of the optical element driving mechanism according to some embodiments of the present disclosure.

FIG. 6A shows a perspective view of the first movable portion and a first magnetically permeable element, a second magnetically permeable element, a third magnetically permeable element, a magnetically permeable element and a connecting element embedded in the first movable portion. For illustration purposes, the first movable portion is shown in dashed lines.

FIG. 6B shows a perspective view of part of the optical element driving mechanism according to some embodiments of the present disclosure.

FIG. 6C shows an exploded view of the second movable portion, the position sensing element, a magnetic element, a coil, magnetically permeable elements and a circuit element.

FIG. 7 is a block diagram of the optical element driving mechanism according to some embodiments of the present disclosure.

FIG. 8 is a partial enlarged view of the optical element driving mechanism in FIG. 6B.

FIG. 9 is a partial cross-sectional view of the optical element driving mechanism taken along line A-A′ of FIG. 1.

### DETAILED DESCRIPTION OF THE INVENTION

Unless otherwise defined, all terms, including technical and scientific terms, used herein have the same meaning as commonly understood by one of ordinary skill in the art to which this disclosure belongs. It is understood that these terms, such as terms defined in commonly used dictionaries, should be interpreted to have a meaning consistent with the background or context of the relevant technology and the present invention, and should not be interpreted in an idealized or overly formal manner, unless otherwise defined herein.

Furthermore, ordinal numbers such as “first,” “second,” etc., used in this specification and claims to modify elements of the claims, do not inherently imply or represent any chronological order of the claimed elements, nor do they signify any sequence between one claimed element and another, or the order of manufacturing methods. The use of such numbers is solely to distinguish one claimed element with a certain name from another claimed element with the same name.

Additionally, in some embodiments of the present invention, terms related to joining or connecting, such as “connect,” “interconnect,” etc., unless specifically defined, can refer to two structures being in direct contact or not in direct contact, with other structures placed between them. Furthermore, these terms related to joining or connecting can include scenarios where both structures are movable or both structures are fixed.

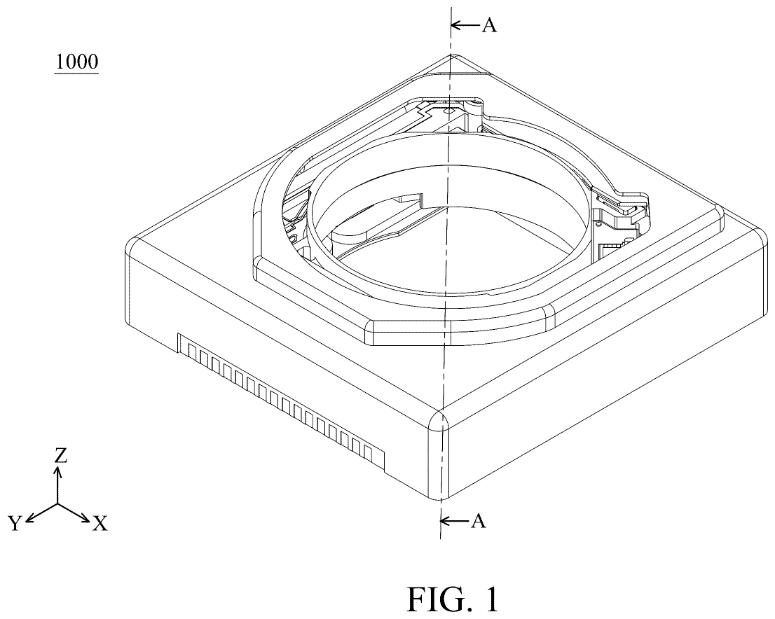

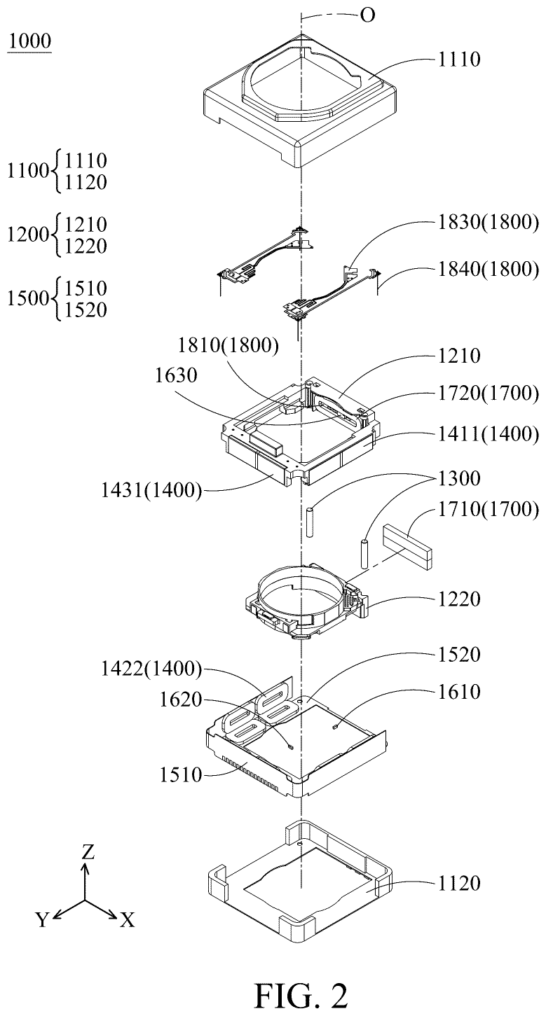

FIG. 1 is a perspective view of an optical element driving mechanism 1000 according to some embodiments of the present disclosure. FIG. 2 is an exploded view of the optical element driving mechanism 1000 according to some embodiments of the present disclosure. Please refer to FIG. 1 and FIG. 2 below.

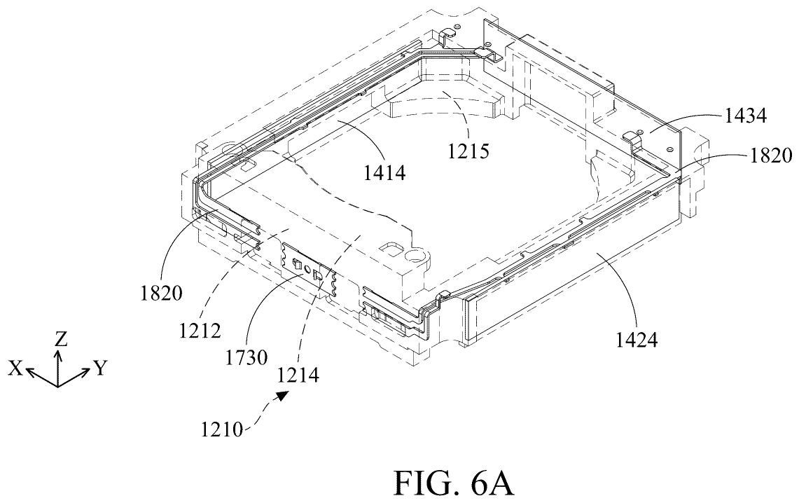

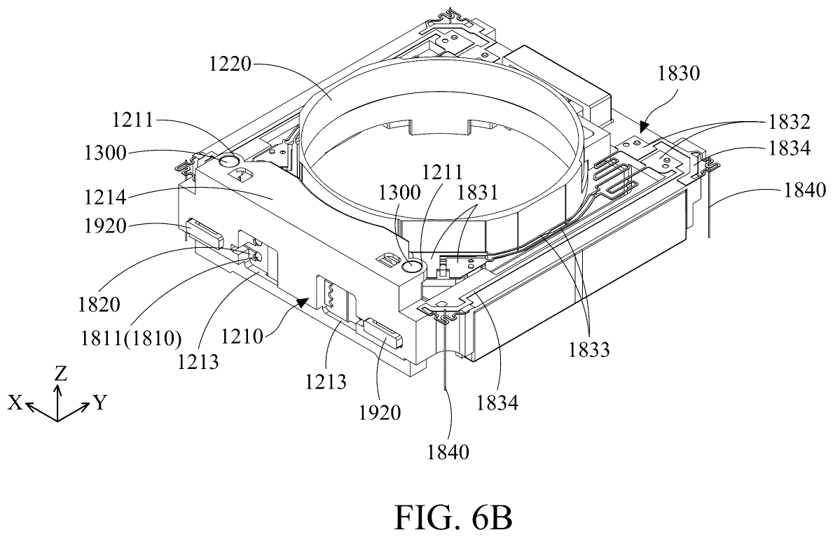

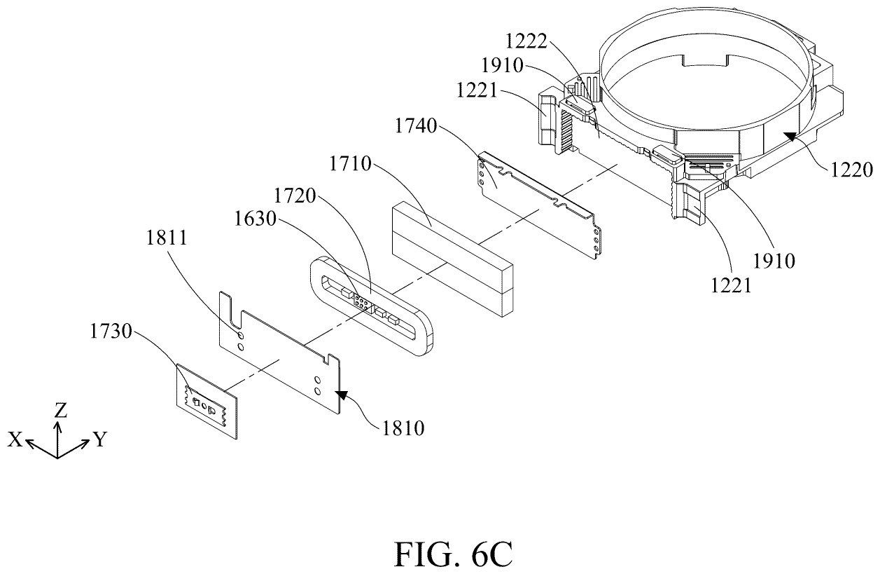

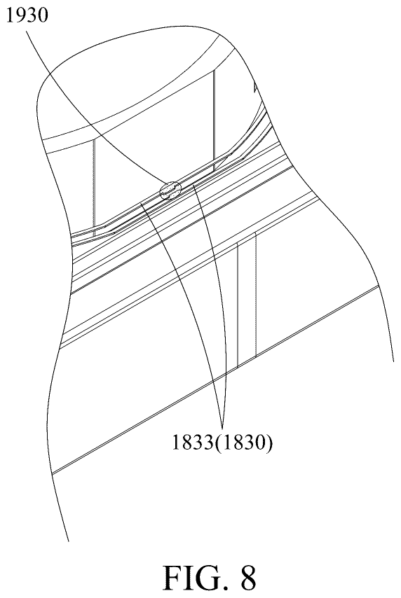

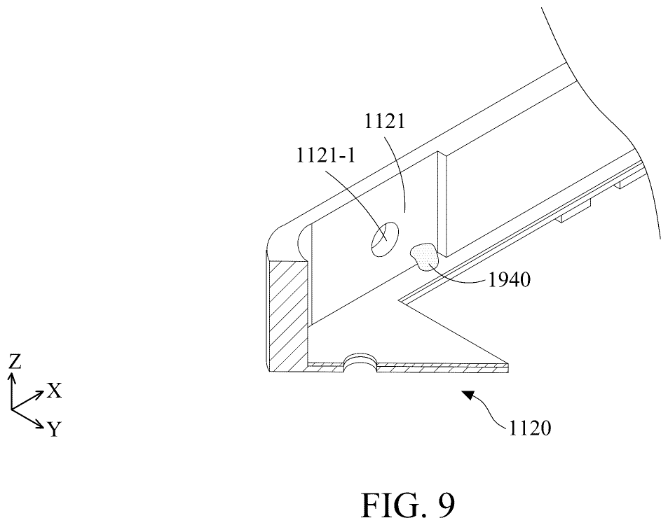

As shown in FIG. 1 and FIG. 2, the optical element driving mechanism 1000 includes a fixed portion 1100, a movable portion 1200, a pair of guide elements 1300, a first driving component 1400, a first circuit component 1500, three position sensing elements 1610, 1620, 1630, a second driving component 1700, a second circuit component 1800 and suppression elements 1910 (FIG. 6C), 1920 (FIG. 6B), 1930 (FIG. 8), 1940 (FIG. 9).

According to some embodiments of the present disclosure, the fixed portion 1100 includes an upper cover 1110 and a base 1120. The upper cover 1110 is fixedly connected to the base 1120 to form a space for accommodating other components of the optical element driving mechanism 1000.

According to some embodiments of the present disclosure, the movable portion 1200 is movable relative to the fixed portion 1100. The movable portion 1200 includes a first movable portion 1210 and a second movable portion 1220. The second movable portion 1220 is movable relative to the first movable portion 1210. The second movable portion 1220 may be a holder connected to an optical element (not shown) having an optical axis O.

Specifically, the first movable portion 1210 is movable relative to the fixed portion 1100 to achieve an optical effect of optical image stabilization (OIS). The second movable portion 1220 is movable relative to the first movable portion 1210 and the fixed portion 1100 to achieve the optical effect of auto focus (AF).

According to some embodiments of the present disclosure, the guide element 1300 may be a pair of guide rods. The guide element 1300 is fixedly provided on the first movable portion 1210. The guide element 1300 may guide the movement of the second movable portion 1220 relative to the first movable portion 1210.

According to some embodiments of the present disclosure, the first driving component 1400 is configured to drive the first movable portion 1210 (which will also drive the second movable portion 1220 carrying an optical element (not shown)) to move relative to the fixed portion 1100.

According to some embodiments of the present disclosure, the first driving component 1400 is electrically connected to the first circuit component 1500. The first circuit component 1500 includes a first circuit element 1510 and a second circuit element 1520. The position sensing element 1610 and the position sensing element 1620 are configured to sense the position of the first movable portion 1210 relative to the fixed portion 1100, the details of which are described in detail below.

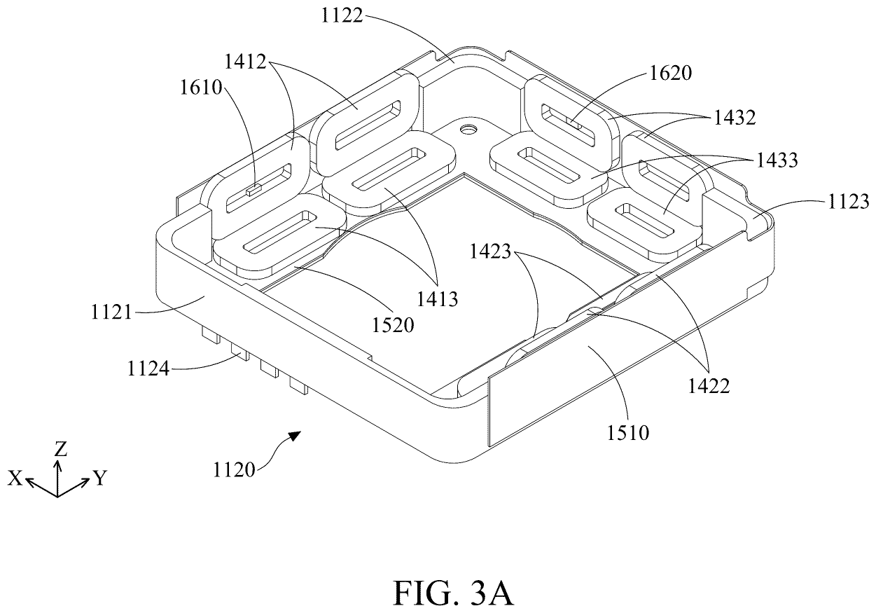

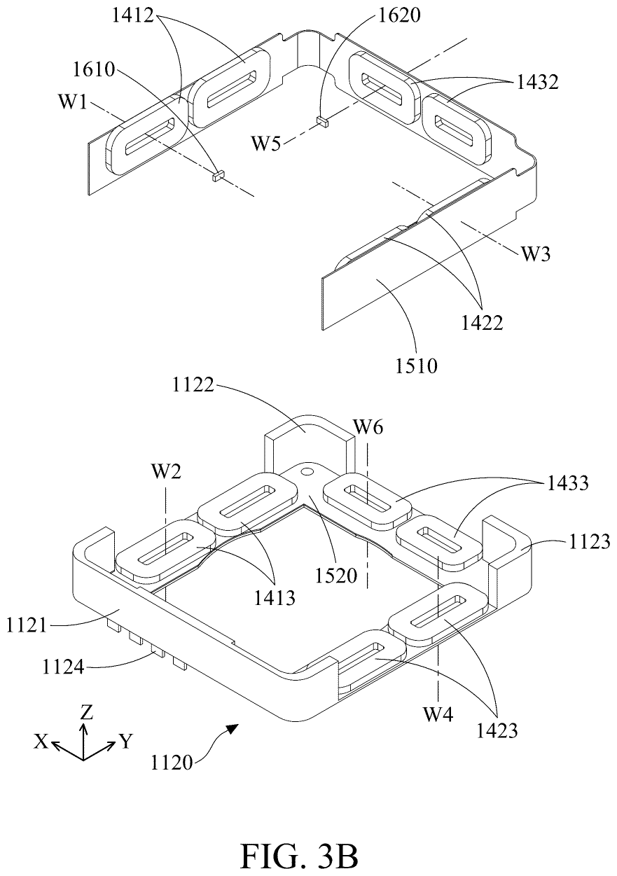

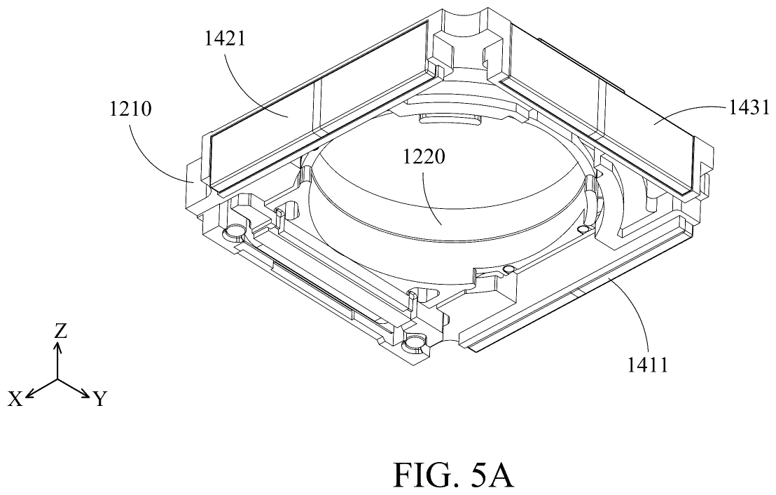

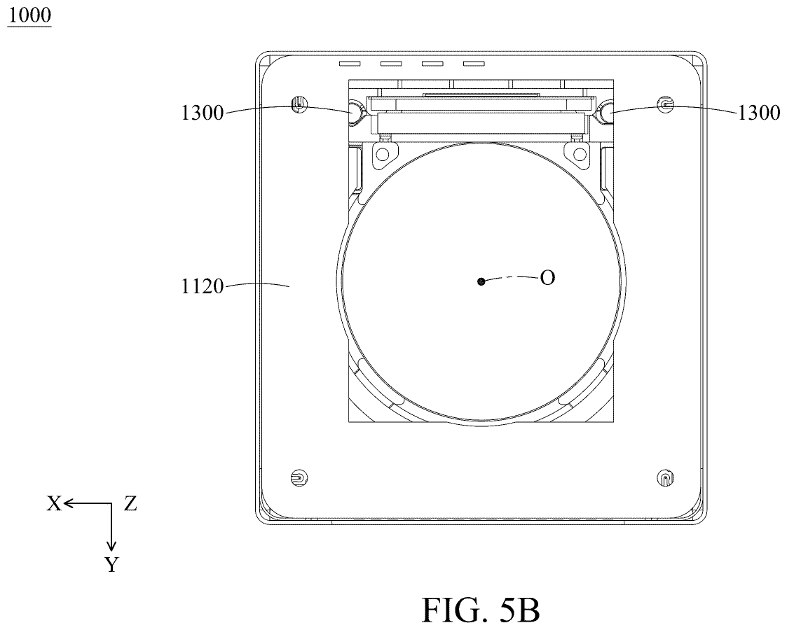

According to some embodiments of the present disclosure, the first driving component 1400 includes a first magnetic element 1411 (FIG. 2), two first coils 1412 (FIG. 3A), two second coils 1413 (FIG. 3A), a first magnetically permeable element 1414 (FIG. 6A), a second magnetic element 1421 (FIG. 5A), two third coils 1422 (FIG. 3A), two fourth coils 1423 (FIG. 3A), a second magnetically permeable element 1424 (FIG. 6A), a third magnetic element 1431 (FIG. 2), two fifth coils 1432 (FIG. 3A), two sixth coils 1433 (FIG. 3A) and a third magnetically permeable element 1434 (FIG. 6A).

As shown in FIG. 2, the first magnetic element 1411 and the third magnetic element 1431 are disposed on the first movable portion 1210. In addition, although the second magnetic element 1421 is obscured from view in the perspective of FIG. 2, it can be seen in FIG. 5A that the second magnetic element 1421 is also disposed on the first movable portion 1210, and the second magnetic element 1421 is disposed on one side of the first movable portion 1210 that is opposite to the first magnetic element 1411. The first magnetic element 1411 is parallel to the second magnetic element 1421.

Please refer to FIG. 2 and FIG. 3A together. The third magnetic element 1431 is not parallel to the first magnetic element 1411 and the second magnetic element 1421. The first coil 1412 and the second coil 1413 correspond to the first magnetic element 1411. The third coil 1422 and the fourth coil 1423 correspond to the second magnetic element 1421. The fifth coil 1432 and the sixth coil 1433 correspond to the third magnetic element 1431.

According to some embodiments of the present disclosure, the first circuit element 1510 is perpendicular to the second circuit element 1520. The first coil 1412, the third coil 1422, and the fifth coil 1432 are disposed on different surfaces of the first circuit element 1510, with each surface facing the optical axis O (see FIG. 2). The second circuit element 1520 is located on a plane perpendicular to the optical axis O.

For example, the first coil 1412 is located on the surface of the first circuit element 1510 opposite to the third coil 1422, and the fifth coil 1432 is located on the surface the first circuit element 1510 perpendicular to the first coil 1412 and the third coil 1422.

Similarly, the second coil 1413 is located on the side of the second circuit element 1520 opposite to the fourth coil 1423, and the sixth coil 1433 is located on the side of the second circuit element 1520 that is adjacent to the second coil 1413 and the fourth coil 1423.

Please refer back to FIG. 2. The position sensing elements 1610 and 1620 are disposed on different sides of the first circuit element 1510. The position sensing elements 1610 and 1620 are configured to sense the movement of the first movable portion 1210 relative to the fixed portion 1100. The position sensing element 1610 corresponds to the first magnetic element 1411. The position sensing element 1620 corresponds to the third magnetic element 1431.

Specifically, the position sensing element 1610 may sense changes in the magnetic field of the first magnetic element 1411, and determine the position of the first movable portion 1210 on the X-axis through a control element (not shown). The position sensing element 1620 may sense changes in the magnetic field of the third magnetic element 1431, and determine the position of the first movable portion 1210 on the Y-axis through the control element (not shown).

According to some embodiments of the present disclosure, the second driving component 1700 is configured to drive the second movable portion 1220 to move relative to the fixed portion 1100 and the first movable portion 1210. The second driving component 1700 includes a magnetic element 1710, a coil 1720 and two magnetically permeable elements 1730 (FIG. 6C) and 1740 (FIG. 6C).

As shown in FIG. 2, the magnetic element 1710 is disposed on the second movable portion 1220, and the coil 1720 is disposed on the first movable portion 1210. In this way, when a driving signal (e.g., applying current from an external power source) is applied to the second driving component 1700, an electromagnetic induction force is generated between the coil 1720 and the magnetic element 1710. This force drives the second movable portion 1220 to move relative to the first movable portion 1210, and consequently relative to the fixed portion 1100, thereby achieving the desired optical effect.

According to some embodiments of the present disclosure, the second driving component 1700 is electrically connected to an external circuit (not shown) via the second circuit component 1800. The second circuit component 1800 includes a circuit element 1810, a connecting element 1820 (FIG. 6A), four elastic elements 1830 and four support elements 1840.

As shown in FIG. 2, the circuit element 1810 is disposed on the side of the first movable portion 1210 that is opposite to the third magnetic element 1431. The position sensing element 1630 and the coil 1720 are disposed on the circuit element 1810. The position sensing element 1630 is configured to sense the movement of the second movable portion 1220 relative to the first movable portion 1210.

Specifically, the position sensing element 1630 corresponds to the magnetic element 1710 disposed on the second movable portion 1220. The position sensing element 1630 may be an all-in-one integrated circuit (IC) that packages both the sensing IC and the control IC within the same package. This allows the position sensing element 1630 to detect the magnetic field changes of the magnetic element 1710 to determine the position of the second movable portion 1220, then control the second movable portion 1220 to move to the desired position, thereby achieving closed-loop control.

According to some embodiments of the present disclosure, the elastic element 1830 may be a spring leaf. The elastic element 1830 movably connects the first movable portion 1210 and the second movable portion 1220. The support element 1840 may be a set of suspension wires. The support element 1840 supports the movement of the movable portion 1200 relative to the fixed portion 1100. The support element 1840 has a wire diameter of approximately 0.06 mm.

It should be noted that although the support element 1840 is generally parallel to the optical axis O, the term “generally parallel” as used herein includes deviations within 5 degrees. Specifically, the end of the support element 1840 closer to the elastic element 1830 is inclined towards the movable portion 1200 at an angle of less than 1 degree to provide more stable support for the movable portion 1200. The upper end of the support element 1840 is connected to the elastic element 1830 through solder. The lower end of the support element 1840 is fixed on the base 1120.

FIG. 3A shows a perspective view of a portion of the first driving component 1400, the first circuit element 1510, the second circuit element 1520 and the position sensing elements 1610 and 1620 that are disposed on the base 1120. FIG. 3B shows an exploded view of a portion of the first driving component 1400, the first circuit element 1510, the second circuit element 1520 and the position sensing elements 1610 and 1620 disposed on the base 1120.

As shown in FIG. 3A, when viewed along the optical axis O (parallel to the Z-axis), the first coil 1412 and the second coil 1413 at least partially overlap. As shown in FIG. 3B, the winding axis W1 of the first coil 1412 and the winding axis W2 of the second coil 1413 are not parallel to each other. Specifically, the winding axis W1 of the first coil 1412 and the winding axis W2 of the second coil 1413 are perpendicular to each other. For example, the winding axis W1 of the first coil 1412 is parallel to the X-axis, and the winding axis W2 of the second coil 1413 is parallel to the Z-axis.

Similarly, the winding axis W3 of the third coil 1422 and the winding axis W4 of the fourth coil 1423 are not parallel to each other, but perpendicular to each other. When viewed along the optical axis O, the third coil 1422 and the fourth coil 1423 at least partially overlap. The winding axis W5 of the fifth coil 1432 and the winding axis W6 of the sixth coil 1433 are not parallel to each other, but perpendicular to each other. When viewed along the optical axis O, the fifth coil 1432 and the sixth coil 1433 at least partially overlap.

As shown in FIG. 3A and FIG. 3B, the position sensing element 1610 is disposed in the hollow position of the annular structure of the first coil 1412, and the position sensing element 1620 is disposed in the hollow position of the annular structure of the fifth coil 1432. When viewed along the direction of the optical axis O, the first coil 1412 at least partially overlaps the position sensing element 1610. When viewed along the direction of the optical axis O, the fifth coil 1432 at least partially overlaps the position sensing element 1620.

It should be noted that positioning the position sensing elements 1610 and 1620 on the side of the optical element driving mechanism 1000 (for example, on the first circuit element 1510) instead of the bottom (for example, on the second circuit element 1520) of the optical element driving mechanism 1000 has a specific effect. That is, even if the movable portion 1200 (FIG. 2) of the optical element driving mechanism 1000 flips, it does not affect the position determination of the position sensing elements 1610 and 1620 on the X-axis and Y-axis. Thus, more accurate position information may be sensed compared to positioning them on the bottom.

According to some embodiments of the present disclosure, the first coil 1412 and the second coil 1413 are configured to generate a driving force to move the movable portion 1200 (FIG. 2) relative to the fixed portion 1100 (FIG. 2) in the first dimension. The motion in the first-dimension refers to the motion on the X-axis in this embodiment.

Similarly, the third coil 1422 and the fourth coil 1423 are also configured to generate a driving force to move the movable portion 1200 (FIG. 2) relative to the fixed portion 1100 (FIG. 2) in the first dimension. The motion in the first-dimension refers to the motion on the X-axis in this embodiment. The first coil 1412, the second coil 1413, the third coil 1422 and the fourth coil 1423 are electrically connected in series. In this way, the first coil 1412, the second coil 1413, the third coil 1422 and the fourth coil 1423 may be driven and controlled at the same time.

In addition, the fifth coil 1432 and the sixth coil 1433 are configured to generate a driving force to move the movable portion 1200 (FIG. 2) relative to the fixed portion 1100 (FIG. 2) in the second dimension. The motion in the second dimension is different from the motion in first dimension. The motion in second dimension refers to the motion on the Y-axis in this embodiment.

As shown in FIG. 3A and FIG. 3B, the base 1120 includes a side wall 1121, two retaining walls 1122, 1123 and a plurality of terminal 1124. The side wall 1121 is located on the side opposite to the fifth coil 1432. The retaining walls 1122 and 1123 are located at two adjacent corners of the base 1120. The terminals 1124 electrically connect the first circuit element 1510 and the second circuit element 1520 to an external circuit (not shown).

According to some embodiments of the present disclosure, the first coil 1412 is positioned between one end of the side wall 1121 and one end of the retaining wall 1122. The third coil 1422 is positioned between one end of the side wall 1121 and one end of the retaining wall 1123. The fifth coil 1432 is positioned between one end of the retaining wall 1122 and one end of the retaining wall 1123.

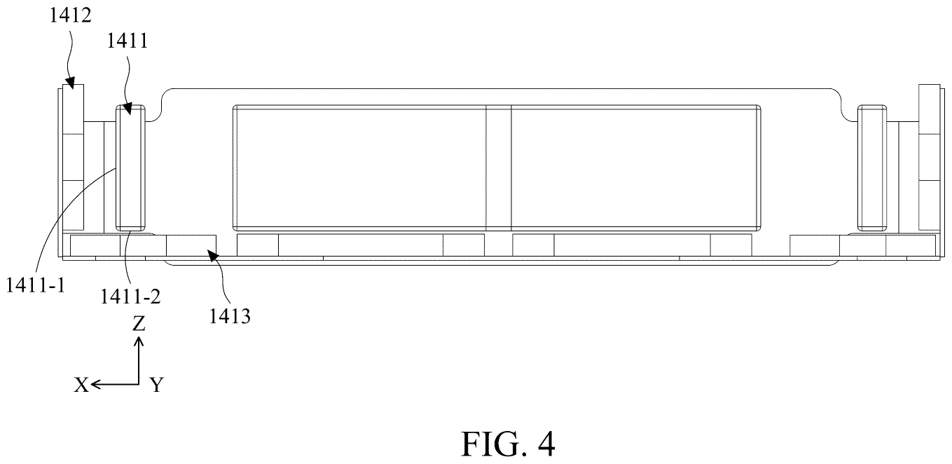

FIG. 4 shows a schematic side view of part of the first driving component 1400. For illustrative purposes, the first magnetic element 1411 can be considered to include a first surface 1411-1 and a second surface 1411-2. The first surface 1411-1 and the second surface 1411-2 face different directions. The first surface 1411-1 faces the first coil 1412, and the second surface 1411-2 faces the second coil 1413.

As shown in FIG. 4, the first surface 1411-1 of the first magnetic element 1411 faces the position sensing element 1610 (FIG. 3B). The shortest distance between the first coil 1412 and the first magnetic element 1411 is different from the shortest distance between the second coil 1413 and the first magnetic element 1411.

It should be noted that when the movable portion 1200 (FIG. 2) moves in the first dimension (movement on the X-axis), the shortest distance between the first surface 1411-1 of the first magnetic element 1411 and the first coil 1412 changes accordingly. change. When the movable portion 1200 moves in the first dimension (movement on the X-axis), the shortest distance between the second surface 1411-2 of the first magnetic element 1411 and the second coil 1413 does not change accordingly.

According to some embodiments of the present disclosure, the structures of the first coil 1412 and the second coil 1413 are different, and the thickness of the first coil 1412 and the thickness of the second coil 1413 are different. For example, in some embodiments, the first coil 1412 may be a flat plate coil, and the second coil 1413 may be a conventional wound coil.

It should be noted that, in the aforementioned coil configuration of the present application, one magnetic element (e.g., first magnetic element 1411) corresponds to two coils oriented perpendicular to each other (e.g., first coil 1412 and second coil 1413). In traditional techniques, coils are typically placed only on the side or underneath the magnetic element (i.e., on one side of the magnetic element). To achieve the driving force realized by the configuration in the present application, traditional techniques would require thicker magnets and larger coils. Therefore, configuring the first driving component 1400 of the present application enables miniaturization and weight reduction of the optical element driving mechanism 1000 while achieving significant driving force.

FIG. 5A shows a perspective view of the first movable portion 1210 and the second movable portion 1220 viewed from bottom to top. As shown in FIG. 5A, when viewed along the optical axis O (parallel to the Z-axis), the first magnetic element 1411 and the second magnetic element 1421 are located on opposite sides of the optical axis. It should be noted that during assembly of the optical element driving mechanism 1000, the guide element 1300 is assembled to the first movable portion 1210 from the +Z direction, which is opposite the direction from which light enters the optical element driving mechanism 1000 (−Z direction).

FIG. 5B shows a bottom view of the optical element driving mechanism 1000 according to some embodiments of the present disclosure. As shown in FIG. 5B, when viewed along the optical axis O, the base 1120 at least partially overlaps with the guide element 1300.

FIG. 6A shows a perspective view of the first movable portion 1210 and the first magnetically permeable element 1414, the second magnetically permeable element 1424, the third magnetically permeable element 1434, the magnetically permeable element 1730 and the connecting element 1820 embedded in the first movable portion 1210. For illustrative purposes, the first movable portion 1210 is shown in dash line.

As shown in FIG. 6A, the first magnetically permeable element 1414 and the second magnetically permeable element 1424 are arranged parallel to each other on the first movable portion 1210. The third magnetically permeable element 1434 is disposed on the first movable portion 1210 and is perpendicular to the first magnetically permeable element 1414 and the second magnetically permeable element 1424. The magnetically permeable element 1730 is parallel to the third magnetically permeable element 1434. The connecting element 1820, which serves as a terminal, is embedded in the first movable portion 1210.

FIG. 6B shows a perspective view of a portion of the optical element driving mechanism 1000 according to some embodiments of the present disclosure. FIG. 6C shows an exploded view of the second movable portion 1220, the position sensing element 1630, the magnetic element 1710, the coil 1720, the magnetically permeable elements 1730, 1740 and the circuit element 1810.

Please refer to FIG. 6B first. Each elastic element 1830 includes a first connection point 1831, a second connection point 1832, a connection line 1833 and an extension portion 1834. The first connection point 1831 and the second connection point 1832 are on opposite ends of the connection line 1833. The first connection point 1831 is disposed on the second movable portion 1220, and the second connection point 1832 is disposed on the first movable portion 1210.

It should be noted that the first connection point 1831 is disposed on the side of the second movable portion 1220 that is closer to the guide element 1300, and the second connection point 1832 is disposed on the side of the first movable portion 1210 that is farther away from the guide element 1300. The connection line 1833 and the extension portion 1834 are connected by the second connection point 1832. The support element 1840 is connected to the extension portion 1834.

Please refer to FIG. 6A and FIG. 6B together. The first movable portion 1210 includes a pair of grooves 1211 (FIG. 6B), a receiving portion 1212 (FIG. 6A), a pair of openings 1213 (FIG. 6B), a first stopper 1214 (FIG. 6A) and a second stopper 1215 (FIG. 6A).

According to some embodiments of the present disclosure, the groove 1211 of the first movable portion 1210 may accommodate the guide element 1300 to fix the guide element 1300 to the first movable portion 1210. The groove 1211 is located on the first stopper 1214 of the first movable portion 1210.

According to some embodiments of the present disclosure, the receiving portion 1212 of the first movable portion 1210 receives the circuit element 1810 disposed thereon (FIG. 6C). As shown in FIG. 6A, the magnetically permeable element 1730 is partially embedded in the receiving portion 1212 of the first movable portion 1210. It should be noted that only part of the magnetically permeable element 1730 is shown in FIG. 6A, and the entire magnetically permeable element 1730 is shown in FIG. 6C.

As shown in FIG. 6C, the position sensing element 1630 and the coil 1720 are disposed on the circuit element 1810 and are electrically connected to the circuit element 1810. The circuit element 1810 is disposed in the receiving portion 1212 of the first movable portion 1210 (FIG. 6A). The circuit element 1810 includes four soldering portions 1811.

As shown in FIG. 6B, the soldering portion 1811 of the circuit element 1810 and the connecting element 1820 connected thereto can be seen from the opening 1213 of the first movable portion 1210. In this way, during assembly of the optical element driving mechanism 1000, by soldering the soldering portion 1811 of the circuit element 1810 and the connecting element 1820 from the opening 1213 of the first movable portion 1210, the circuit element 1810 can be electrically connected to the connecting element 1820.

In other words, during assembly of the optical element driving mechanism, the circuit element 1810 is soldered from the side facing away from the optical axis O, thereby electrically connecting the circuit element 1810 to the connecting element 1820.

According to some embodiments of the present disclosure, when the second movable portion 1220 moves to a first limit position along the optical axis O, the second movable portion 1220 contacts the first stopper 1214. Specifically, before the second movable portion 1220 contacts the first stopper 1214, the suppression element 1910 (FIG. 6C) provided on the second movable portion 1220 will first contact the lower surface of the first stopper 1214 (FIG. 6B) to achieve a buffer effect. The suppression element 1910 described herein may be made of materials such as rubber.

Similarly, when the second movable portion 1220 moves to a second limit position along the optical axis O, the second movable portion 1220 contacts the second stopper 1215. Specifically, before the second movable portion 1220 contacts the second stopper 1215, the suppression element (not shown) provided on the second movable portion 1220 will first contact the upper surface of the second stopper 1215 (FIG. 6A) to achieve a buffer effect. The suppression element described herein may be made of materials such as rubber.

According to some embodiments of the present disclosure, the magnetically permeable element 1740 is embedded in the containing portion 1222 of the second movable portion 1220. The magnetic element 1710 is located in the containing portion 1222 of the second movable portion 1220. The magnetically permeable element 1730 is partially embedded in the first movable portion 1210 (FIG. 6A), and the circuit element 1810 is connected to the magnetically permeable element 1730.

In this way, an attractive force is generated between the magnetic element 1710 disposed on the second movable portion 1220 and the magnetically permeable element 1730 disposed on the first movable portion 1210, causing the second movable portion 1220 to lean towards the guide element 1300 (FIG. 6B). This results in smoother movement of the second movable portion 1220 relative to the first movable portion 1210, reducing the likelihood of shaking, overturning, or similar issues.

As shown in FIG. 6B, suppression elements 1920 are provided on the opening 1213 side of the first movable portion 1210 to buffer possible impact between the first movable portion 1210 and the fixed portion 1100 (FIG. 2). In detail, the suppression elements 1910 (FIG. 6C) and 1920 of the present disclosure each have a hollow structure and are made of rubber, which can be used to suppress noise and buffer impact force.

As shown in FIG. 6A and FIG. 6C, the first magnetically permeable element 1414, the second magnetically permeable element 1424, the third magnetically permeable element 1434 and the magnetically permeable element 1740 may enhance the magnetic force of the corresponding first magnetic element 1411, the second magnetic element 1421, the third magnetic element 1431 and the magnetic element 1710.

It should be understood that the coil 1720 (FIG. 6C) of the second driving component 1700 is electrically connected to an external circuit (not shown) in sequence through the circuit element 1810 (FIG. 6C), the connecting element 1820 (FIG. 6A), the elastic element 1830 (FIG. 6B), and the support element 1840 (FIG. 6B).

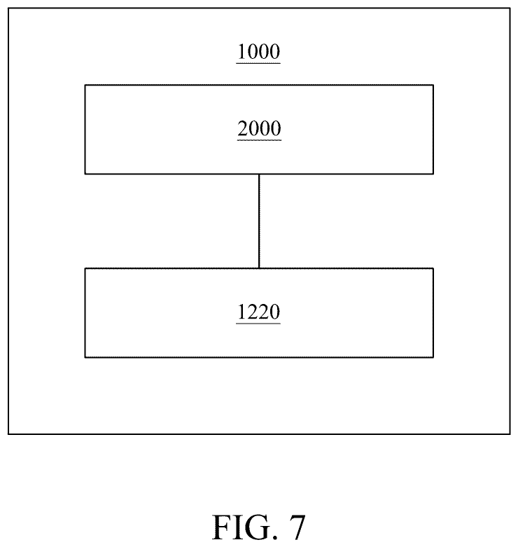

FIG. 7 is a block diagram of the optical element driving mechanism 1000 according to some embodiments of the present disclosure, in which an aperture mechanism 2000 is mounted on the second movable portion 1220. That is to say, the aperture mechanism 2000 is disposed on the second movable portion 1220 to control the amount of light entering the second movable portion 1220 to achieve the required optical effect.

It should be noted that the aperture mechanism 2000 is electrically connected to the elastic element 1830 via the first connection point 1831 (FIG. 6B) of the elastic element 1830. The circuit element 1810 (FIG. 6B) is electrically connected to the second connection point 1832 (FIG. 6B) of the elastic element 1830 via the connecting element 1820 (FIG. 6B).

FIG. 8 is a partial enlarged view of the optical element driving mechanism 1000 of FIG. 6B. As shown in FIG. 8, the suppression element 1930 is provided between the respective connection lines 1833 of the two elastic elements 1830 to prevent the connection lines 1833 of the elastic elements 1830 from colliding together and causing damage, for example, to prevent the elastic elements 1830 from causing a short circuit due to collision. It should be noted that the suppression element 1930 described herein be gel. In some embodiments, the suppression element 1930 may be a non-conductive material. The suppression element 1930, while being provided between the respective connection lines 1833 of the two elastic elements 1830, may also contact at least one of the first movable portion 1210 and the second movable portion 1220.

FIG. 9 is a partial cross-sectional view of the optical element driving mechanism 1000 taken along line A-A′ in FIG. 1. It should be noted that, although not shown in FIGS. 3A and 3B, the side wall 1121 of the base 1120 may include an opening 1121-1 as shown in FIG. 9. During assembly of optical element driving mechanism 1000, the suppression element 1940 may be applied to the inside of base 1120 from outside of base 1120 through the opening 1121-1. The suppression element 1940 described herein may be gel.

It should be noted that the suppression element 1940 is applied near the corner of the base 1120 through the opening 1121-1, specifically close to the support element 1840 (FIG. 2). In this way, the suppression element 1940 may absorb the naturally occurring resonance frequency within the optical element driving mechanism 1000 to suppress the shaking or flipping of the support element 1840 due to the aforementioned resonance frequency, thereby achieving the effect of stabilizing the structure.

In summary, the special configuration of the driving component in the present application enables the optical element driving mechanism to use small and lightweight driving components to move a larger movable portion. Additionally, the aperture mechanism can be electrically connected to the movable portion through the specialized structure of the miniaturized circuit components of this invention, and the optical element driving mechanism of this invention is equipped with suppression elements that have different effects, which make the overall structure more stable.

Although the embodiments and their advantages of the present invention have been disclosed above, it should be understood that any modification and substitution can be made by anyone with ordinary skill in the art without departing from the spirit and scope of the present disclosure. In addition, each claim constitutes an individual embodiment, and the protection scope of the present disclosure also includes the combination of each claim and embodiments.

What is claimed is:

1. An optical element driving mechanism, comprising:
a fixed portion;
a movable portion connected to an optical element having an optical axis, wherein the movable portion is movable relative to the fixed portion; and
a first driving component configured to drive the movable portion to move relative to the fixed portion.

2. The optical element driving mechanism as claimed in claim 1, wherein the movable portion comprises a first movable portion and a second movable portion, and the second movable portion is movable relative to the first movable portion.

3. The optical element driving mechanism as claimed in claim 2, further comprising a guide element, wherein the guide element guides the movement of the second movable portion relative to the first movable portion.

4. The optical element driving mechanism as claimed in claim 3, wherein the fixed portion comprises a base that at least partially overlaps the guide element when viewed along the optical axis.

5. The optical element driving mechanism as claimed in claim 3, wherein during assembly of the optical element driving mechanism, the guide element is assembled to the first movable portion from a direction opposite the direction in which light enters the optical element driving mechanism.

6. The optical element driving mechanism as claimed in claim 3, wherein the first movable portion comprises a first stopper, and when the second movable portion moves to a first limit position along the optical axis, the second movable portion contacts the first stopper.

7. The optical element driving mechanism as claimed in claim 6, wherein the first movable portion further comprises a second stopper, and when the second movable portion moves to a second limit position along the optical axis, the second movable portion contacts the second stopper.

8. The optical element driving mechanism as claimed in claim 6, wherein the first movable portion further comprises a groove, the groove accommodates the guide element to fix the guide element on the first movable portion, and the groove is located on the first stopper of the first movable portion.

9. The optical element driving mechanism as claimed in claim 3, further comprising a second driving component, wherein the second driving component is configured to drive the second movable portion to move relative to the fixed portion and the first movable portion.

10. The optical element driving mechanism as claimed in claim 9, further comprising a first circuit component, wherein the first driving component is electrically connected to the first circuit component, the first circuit component comprises a first circuit element and a second circuit element, and the first circuit element and the second circuit element are perpendicular to each other.

11. The optical element driving mechanism as claimed in claim 10, further comprising a second circuit component, wherein the second driving component is electrically connected to an external circuit via the second circuit component.

12. The optical element driving mechanism as claimed in claim 11, wherein the first driving component comprises a first magnetically permeable element, a second magnetically permeable element and a third magnetically permeable element, and the second driving component comprises two magnetically permeable elements, the first magnetically permeable element and the second magnetically permeable element are arranged parallel to each other on the first movable portion, the third magnetically permeable element is disposed on the first movable portion and perpendicular to the first magnetically permeable element and the second magnetically permeable element, the magnetically permeable elements are parallel to the third magnetically permeable element, one of the magnetically permeable elements is disposed on the first movable portion, and the other of the magnetically permeable elements is disposed on the second movable portion.

13. The optical element driving mechanism as claimed in claim 11, wherein the second circuit component comprises a circuit element, a connecting element, an elastic element and a support element; the second driving component is electrically connected to the external circuit sequentially through the circuit element, the connecting element, the elastic element, and the support element; the connecting element is embedded in the first movable portion, the support element supports the movement of the movable portion relative to the fixed portion, the support element is generally parallel to the optical axis, with one end of the support element closer to the elastic element is inclined toward the movable portion at an angle of less than 1 degree, and the support element has a wire diameter of approximately 0.06 mm.

14. The optical element driving mechanism as claimed in claim 13, wherein during assembly of the optical element driving mechanism, the circuit element is soldered from a side facing away from the optical axis, so that the circuit element is electrically connected to the connecting element.

15. The optical element driving mechanism as claimed in claim 13, wherein the elastic element comprises a first connection point, a second connection point and a connection line, and the first connection point and the second connection point are located at opposite ends of the connection line, the first connection point is disposed on the second movable portion, and the second connection point is disposed on the first movable portion.

16. The optical element driving mechanism as claimed in claim 15, wherein an aperture mechanism is disposed on the second movable portion, and the aperture mechanism is electrically connected to the elastic element via the first connection point of the elastic element.

17. The optical element driving mechanism as claimed in claim 15, wherein the circuit element is electrically connected to the second connection point of the elastic element via the connecting element.

18. The optical element driving mechanism as claimed in claim 15, wherein the first connection point is disposed on a side of the movable portion that is closer to the guide element, and the second connection point is disposed on the movable portion on a side further away from the guide element.

19. The optical element driving mechanism as claimed in claim 1, further comprising a suppression element, wherein the fixed portion comprises a base, and the base comprises an opening, and during assembly of the optical element driving mechanism, the suppression element is applied to the inside of the base from outside the base through the opening.

20. The optical element driving mechanism as claimed in claim 1, further comprising two elastic elements and a suppression element, and the suppression element is provided between the elastic elements.
